(19) United States
(12) Patent Application Publication
(10) Pub. No.: US 2006/0021312 A1
(43) Pub. Date: Feb. 2, 2006

(54) Electronic control module for mower

(76) Inventors: Dennis Brandon, Brentwood, TN (US); James Dayton, Nashville, TN (US)

Correspondence Address: W. EDWARD RAMAGE, COMMERCE CENTER SUITE 1000, 211 COMMERCE ST, NASHVILLE, TN, 37201, US

(21) Appl. No.: 10/899,697

(22) Filed: Jul. 27, 2004

(51) Int. Cl. A01D 41/127

(52) U.S. Cl. 56/10.2 R

(57) ABSTRACT

An electronic control module to monitor and control various functions and conditions of a mower, and to display information about such functions and conditions to the operator of the mower. Information is accepted from a variety of switches and sensors on the various components of the mower, and information about certain mower functions can be displayed by means of LEDs or a LCD on a display module, which may be integrated with the central control module.

### FIELD OF INVENTION

This invention relates generally to an electronic control module to monitor and control various functions and conditions of a mower, and to display information about such functions and conditions to the operator of the mower.

### BACKGROUND OF THE INVENTION

The operation of lawn mowers, particularly riding lawn mowers, has been increasingly complex. The scope of functions to be monitored and conditions to be checked prior to and during mower operations has grown with improvements in mower technology and changes in safety regulations. Current devices monitor some functions and provide limited feedback to the operator in the form of light-emitting diodes (“LEDs”) that glow as warning indicators when certain conditions are met. Such devices, for example, cause a LED to be lit when the fuel is running low, the engine needs servicing, the battery charge is low, or the oil pressure is low. Other devices may include an amperage gage or hours-of-operation meter. Little additional information is available to the operator, however. Moreover, such systems provide little or no guidance to the operator regarding what steps or actions to take to correct such conditions or problems.

In addition to limited feedback, current systems in use require high voltage running through the chassis of the mower, which results in inefficient grounding and a substantial amount of electrical noise. In addition, the high voltage used requires larger size, more expensive components. Such systems also have limited functionality in monitoring and controlling mower operating systems, and do not adapt easily to changes in safety regulations.

Thus, what is needed is an efficient, inexpensive means of monitoring and controlling many different conditions and functions on a mower, and a means of providing information and feedback to the operator.

### SUMMARY OF THE INVENTION

This invention is directed towards an electronic control module to monitor and control various functions and conditions of a mower, and to display information about such functions and conditions to the operator. The present invention is particularly described in connection with a riding lawn mower, but may of course be used in any similar application.

Current devices monitor some mower functions and provide limited feedback to the operator in the form of light-emitting diodes (“LEDs”) that glow as warning indicators when certain conditions are met. Little additional information is available to the operator, however, beyond a light indicating that the condition exists. Moreover, such systems provide little or no guidance to the operator regarding what steps or actions to take to correct such conditions or problems. In addition to limited feedback, current systems in use require high voltage running through the chassis of the mower, which results in inefficient grounding and a substantial amount of electrical noise. The high voltage used also requires larger size, more expensive components. Such systems also have limited functionality in monitoring and controlling mower operating systems, and do not adapt easily to changes in safety regulations.

In one exemplary form, the present invention improves upon the above-described systems by providing an efficient, inexpensive means of monitoring and controlling a wide range of mower conditions and functions. The present invention uses low voltage, thus reducing the cost of switches, wires and other components used, ensuring proper grounding, and reducing electrical noise. The electronic control module is programmed so that operation of the mower complies with applicable safety regulations, and can be modified to meet future changes in regulations. A display module, which can be a separate unit or integrated with the central control module, displays detailed diagnostic information to help the consumer operate the mower, which can reduce the number of inquiries from consumers as well as provide for easier troubleshooting by service technicians. In addition, a language key module can be added to allow the information to be displayed in different languages, thus increasing potential markets for the mowers.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a perspective view of an embodiment of the invention with a separate display module and central control module.

FIG. 2 is a perspective view of an embodiment of the invention with an integrated display module and central control module.

FIG. 3 is an side view of the embodiment of the invention shown in FIG. 2.

FIG. 4 is a diagram of various input and output functions and features of an embodiment of the invention.

### DESCRIPTION OF THE EXEMPLARY EMBODIMENTS

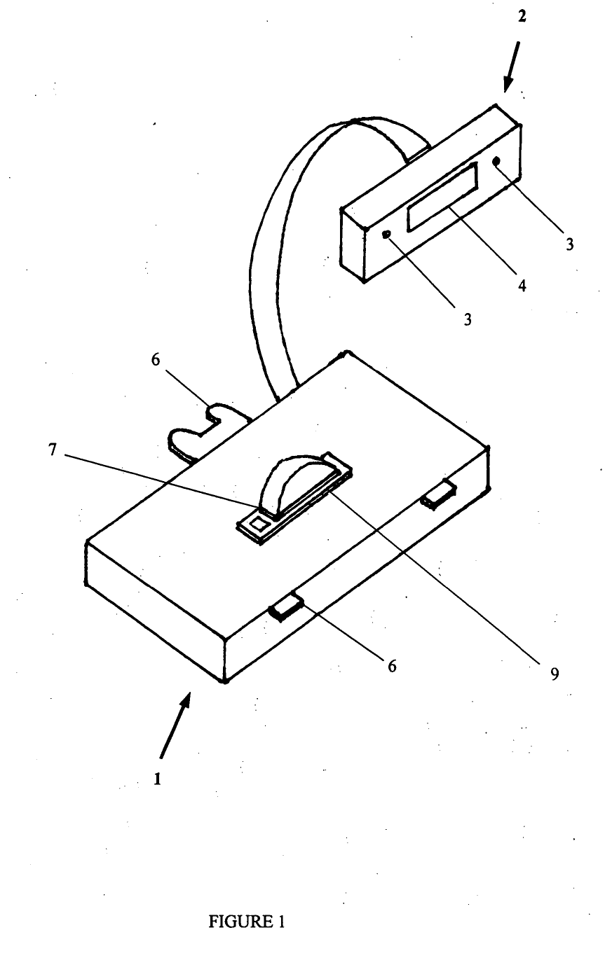

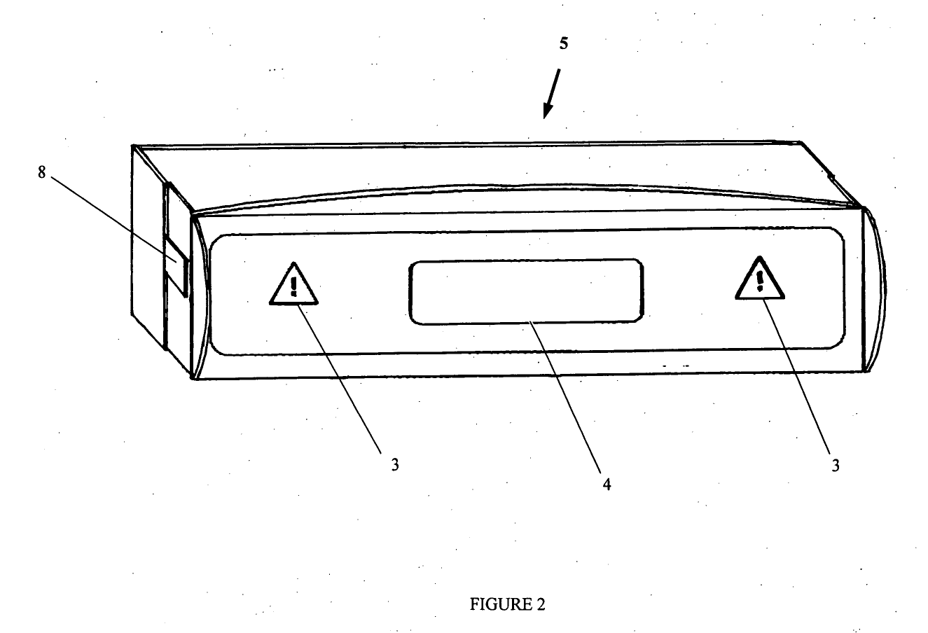

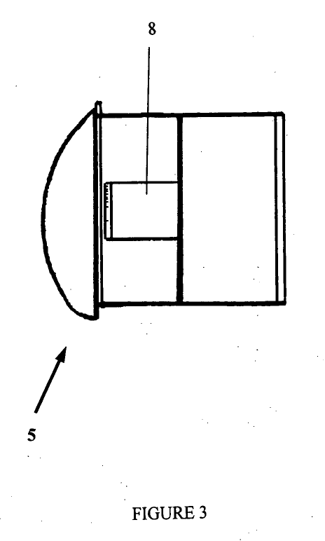

One exemplary embodiment, as seen in FIG. 1, shows the general configuration of a central control module 1 electrically connected to a separate display module 2. Alternatively, as shown in FIGS. 2 and 3, the display module 2 can be integrated with the central control module 1 into a single unit 5. The display module 2 can provide basic information about certain mower functions through LEDs 3, or more detailed alphanumeric information though a liquid crystal display (“LCD”) 4. In an alternative embodiment, the display module 2 may use both LEDs 3 and a LCD 4 to display information.

In one embodiment as shown in FIG. 1, one or more tabs 6 extend from the edges of the central control module 1. These tabs 6 may vary in size and placement, and are designed to allow the central control module 1 to be fastened into a appropriate slot or cutout on the mower (not shown) by a sideways sliding motion. The central control module 1 may thus be mounted in place without tools or separate fastening devices such as screws or bolts, and may, in fact, be accomplished with one hand. In particular, this feature allows for fast and efficient mounting of the central control module 1 during production and assembly of the mower (not shown), as well as easy removal and replacement. Similarly, mounting tabs 8 may be located on the sides of the display module 2 or the integrated unit 5, to permit mounting in place without tools or separate fastening devices.

The central control module 1 accepts input from a variety of switches and sensors (not shown) on various components of the mower. The number, types, and configuration of input sources varies with the type, model, and manufacturer of the mower.

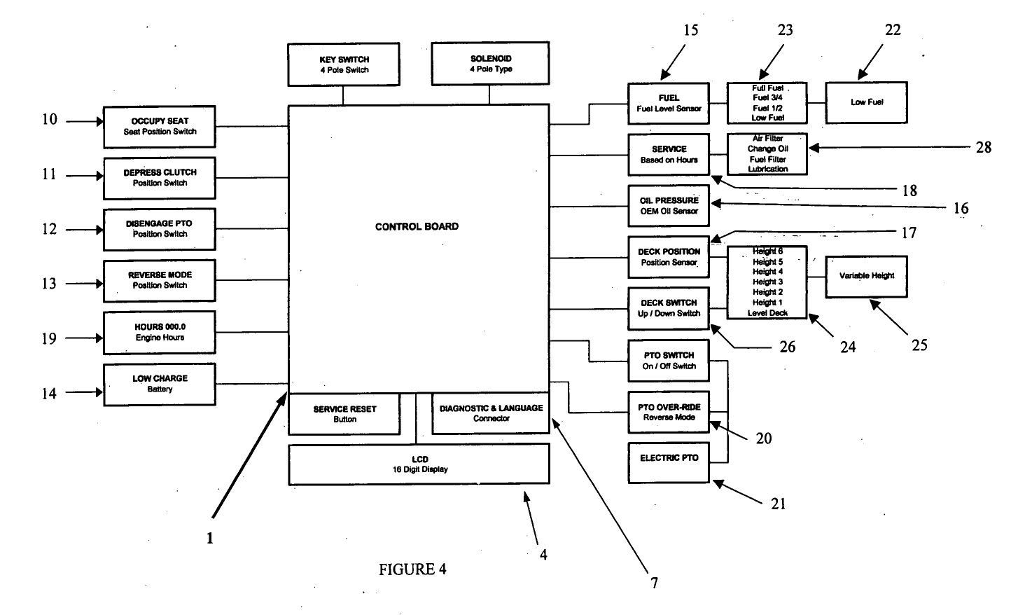

As diagrammed in FIG. 4, a set of input data on many mowers can include data from a seat occupied switch 10, clutch depressed switch 11, Power Take Off (“PTO”) switch (i.e., power to the cutting blades) 12, reverse mode switch 13, the battery 14, fuel tank sensor 15, oil pressure sensor 16, and one or more mower cutting deck height position sensors 17. The invention also keeps track of elapsed engine time 19, which is the sum total of the amount of time the engine has been turned on and running. The central control module 1 typically provides information about these functions through the display module 2, as described above.

Current safety regulations require that the mower engine not be allowed to start unless all of the following conditions are met: (1) the operator is in the mower seat; (2) the clutch is depressed; and (3) the PTO (i.e., power to the cutting blades) is disengaged. The invention in one exemplary form monitors these three conditions by means of the above input, and also provides information to guide and instruct the operator. Accordingly, in one exemplary form, if the operator turns the key to start the mower engine, and the operator is not in the seat as indicated by input from the seat occupied switch 10, then the display module 2 LCD 4 will read “OCCUPY SEAT” or some similar message, and the central control module 1 will not allow the engine to start. If the operator is in the seat, but the clutch is not depressed as indicated by input from the clutch depressed switch 11, the display module 2 LCD 4 will read “DEPRESS CLUTCH” or some similar message, and the central control module 1 will not allow the engine to start. If the operator is in the seat and the clutch is depressed, but the PTO is engaged as indicated by input from the PTO switch 12, then the display module 2 LCD 4 will read “DISENGAGE PTO” or some similar message, and the central control module 1 will not allow the engine to start until the PTO is disengaged.

The central control module 1 also controls similar safety functions during the operation of the mower. For example, if the engine is running and the operator gets off of the mower seat as indicated by input from the seat occupied switch 10, the central control module 1 will detect that change in status and cause the engine to shut off.

The invention also addresses a new safety requirement for mowers with regard to operation of the mower in reverse. If the operator puts the mower into reverse, the central control module 1 will detect that condition through input from the reverse mode switch 13 and one of two results will occur, depending upon whether the power to the cutting blades (i.e., the “PTO”) is controlled by means of a manual lever or electric clutch (not shown). If a manual lever is used, the engine will be shut off. The operator then will be prompted to disengage the PTO by operation of the manual lever in order to continue operating the mower. If an electric clutch is used, the PTO is disengaged and the mower is not shut off. Because the operator may desire in some circumstances to engage the mower blades while the mower runs in reverse, the central control unit 1 is programmed to allow the operator to override this reverse-mode control 20 and allow the mower to continue in reverse with the mower blades engaged.

Another advantage of the electronic control module 1 exists with regard to mowers with electric clutches used to engage and disengage the PTO 21. At present, the manner in which such electric clutches are engaged causes a distinctive shock to various pulleys and belts used in the mechanism to drive the cutting blades. In one exemplary embodiment, the electronic control module 1 can be programmed to cause an electric clutch to engage more slowly and smoothly, thus greatly reducing the wear and tear on the drive mechanism and the clutch itself.

The central control unit 1 can be adapted to display information about mower conditions and functions in various degrees of accuracy. For example, in one exemplary configuration, the central control unit 1 will cause a low fuel LED 3 or “LOW FUEL” message 22 to display when the fuel level in the fuel tank reaches a certain level. In an alternative configuration, the central control unit 1 will cause the display module 2 using a LCD 4 to display an alphanumeric message regarding the amount of fuel remaining in the tank, such as “FULL FUEL,” “¾ FUEL,” “½ FUEL,” or “LOW FUEL” 23.

Similarly, the central control unit 1 can report the relative height or position of the mower cutting deck, by causing the display module 2 using a LCD 4 to display an alphanumeric message such as “DECK POSITION 0,” “DECK POSITION 1,” “DECK POSITION 2,” or similar messages 24. The central control unit 1 can be programmed to cause the mower cutting deck to be raised or lowered to a particular height or position, or a variable height or position somewhere between ground level and the maximum cutting height 25. In the latter instance, the central control unit 1 can then report the relative height or position of the mower cutting deck to any desired degree of accuracy through the LCD 4 on the display module 2. The desired height or position can be achieved by the mower operator by means of a deck height switch, a multi-positional switch, a series of buttons for pre-set heights, or similar means 26.

In another alternative embodiment, the central control unit 1 can be programmed to implement a deck fault mode. When the cutting deck is being raised or lowered to a new position, the central control unit 1 monitors the time it takes for the cutting deck to move to a new position. If the time elapsed is greater than a time calculated by the central control unit 1, the motor or device raising or lowering the cutting deck is shut off. Alternatively, when the cutting deck is being raised or lowered to a new position, the central control unit 1 monitors the electric current to the motor or device causing the cutting deck to be raised or lowered. A sudden spike or dramatic increase in the electric current indicates that the cutting deck has run into the ground or an obstacle, and the motor or device raising or lowering the cutting deck can be shut off.

In yet another alternative embodiment, multiple deck lift assemblies (not shown) may be used to raise or lower different sides of the cutting deck, and can be operated either together or independently. In such configurations, the central control unit 1 can receive data from two or more deck height position sensors 17 and can control the front-to-back and/or side-to-side positioning of the cutting deck. A typical configuration when two deck lift assemblies are used is to position one on the right side and one on left side of the mower, where the can be operated independently or in tandem. The alphanumeric message on the display module 2 would identify which deck height position sensor was being reported along with the height information.

In yet another embodiment, the central control module 1 can be programmed to assist in the function of leveling the cutting deck of the mower. When the deck leveling operation is initiated by the operator, the central control module 1 causes the mower engine to turn off and directs the operator through the steps to mechanically level the cutting deck. Leveling also can be performed automatically from side-to-side or front-to-back when multiple deck lift assemblies are present. For example, when two deck lift assemblies are present, both deck lift assemblies can be directed to lower their respective sides of the cutting deck to the ground. When the central control module 1 detects a dramatic increase in the electric current to the respective motor or device lowering that side of the lift, thus indicating contact with the ground, the motor or device is shut off. When both devices indicate contact with the ground, the deck height for both sides is calibrated to zero. Automatic deck leveling mode is exited, and both sides of the deck are raised in equal increments. Alternatively, when complete, the central control module 1 can cause the cutting deck to return to the height or position it was in prior to the initiation of the deck leveling operation.

In still another alternative embodiment, the central control module 1 can use a LCD display module 2 to display the elapsed engine time 19, typically in total hours with an accuracy of a tenth of an hour. The central control unit 1, however, also can use the elapsed engine time 19 to determine if and when servicing needs to be done 18, the type of servicing needed, and whether the unit is covered under warranty. With a LED display module 2, the central control module 1 will simply cause one or more LEDs 3 to light up, indicating that servicing is needed. With a LCD display module 2, the central control module 1 will cause the LCD 4 to display an appropriate alphanumeric message regarding the servicing needed, such as “CHANGE OIL,” “FUEL FILTER,” “AIR FILTER,” or “LUBRICATION” 28.

In another embodiment, a diagnostic or language key module 7 can be plugged into an appropriate plug or input means 9 on the central control module 1. As a diagnostic key module 7, the module could be programmed to perform diagnostic functions and testing on the central control module 1 and display module 2, whether separate or integrated, and the various input and output features described above. The diagnostic key module 7 can also be programmed to test the operation and detect the presence of various input switches and devices on the mower, and adjust the display depending on what input switches and devices are present. For example, if the diagnostic tests are passed, the elapsed engine time 19 hours can be set to zero, and if an electric deck lift assembly is detected, the deck is raised to a height suitable for shipping. Similarly, the default display can be set based on whether an electric deck lift assembly is detected: if a deck lift assembly is detected, the display defaults to deck height; if not, the display defaults to elapsed hours. As a language key module 7, the module could be programmed to cause the output on a LCD 4 to be displayed in a particular language.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. An electronic control module for a mower, comprising:
a. a central control module, adapted for monitoring and controlling certain condition and functions of the mower; and
b. a display module, electrically connected to the control module, for displaying information about mower conditions and functions received from the central control module.

2. The electronic control module of claim 1, further wherein the display module displays information about mower conditions and functions through a plurality of light-emitting diodes.

3. The electronic control module of claim 1, further wherein the display module displays information about mower conditions and functions in alphanumeric form through a liquid crystal display.

4. The electronic control module of claim 1, further wherein the display module displays some information about mower conditions and functions through a combination of plurality of light-emitting diodes and a liquid crystal display.

5. The electronic control module of claim 1, wherein the display module is integrated with the central control module.

6. The electronic control module of claim 1, wherein the conditions and functions of the mower monitored and controlled by the central control module comprise
a. a seat occupied switch, adapted to determine whether the mower seat is occupied;
b. a clutch depressed switch, adapted to determine whether the mower clutch is depressed;
c. a Power Take Off switch, adapted to determine whether the power to the mower blades is off; and
d. a reverse mode switch, adapted to determine whether the mower is being driven in reverse.

7. The electronic control module of claim 1, wherein the conditions and functions of the mower monitored and controlled by the central control module further comprise
a. an elapsed engine time function, adapted to determine the sum total of the hours the mower engine has run;
b. a battery charge sensor, adapted to determine the level of charge on the mower battery.
c. a fuel level sensor, adapted to determine the amount of fuel in the mower fuel tank;
d. an oil pressure sensor, adapted to determined the oil pressure in the mower engine;
e. one or more mower cutting deck height position sensors, adapted to determine the height of the mower cutting deck or a side of the mower cutting deck;
f. one or more mower cutting deck input devices, adapted to cause the mower cutting deck or a side of the mower cutting deck to be raised or lowered; and
g. a service function, adapted to determine what servicing of the mower is needed based on the elapsed engine time.

8. The electronic control module of claim 6, further wherein the central control module is programmed to not allow the mower engine to start unless the mower seat is occupied, the mower clutch is depressed, and the power to the mower blades is off.

9. The electronic control module of claim 8, wherein the central control module is programmed to cause the display module to display an appropriate signal or message to the operator indicating that the mower seat needs to be occupied, or the mower clutch needs to be depressed, or the power to the mower blades needs to be disengaged.

10. The electronic control module of claim 6, further wherein the central control module is programmed to cause the mower engine to be shut off if the seat occupied switch ever indicates that the mower seat has become unoccupied.

11. The electronic control module of claim 6, further wherein the central control module is programmed to cause the mower engine to be shut off if the reverse mode switch indicates the mower is being driven in reverse.

12. The electronic control module of claim 6, further wherein the Power Take Off switch is adapted to cause power to the mower blades to be turned on or off.

13. The electronic control module of claim 12, further wherein the central control module is programmed to cause the power to the mower blades to shut off if the reverse mode switch indicates the mower is being driven in reverse, unless the mower operator selects to override the reverse mode switch.

14. The electronic control module of claim 6, wherein the central control module is programmed to cause the display module to display an appropriate signal or message if there is a low charge on the mower battery.

15. The electronic control module of claim 7, wherein the central control module is programmed to cause the display module to display an appropriate signal or message if there is a low level of fuel in the mower fuel tank, or to display a message indicating the amount of fuel in the mower fuel tank.

16. The electronic control module of claim 7, wherein the central control module is programmed to cause the display module to display an appropriate signal or message indicating the height or position of the mower cutting deck.

17. The electronic control module of claim 7, wherein the central control module is programmed to cause the display module to display an appropriate signal or message if there is low oil pressure.

18. The electronic control module of claim 7, wherein the central control module is programmed to cause the display module to display an appropriate signal or message indicating current engine speed.

19. The electronic control module of claim 6, wherein the central control module is programmed to cause the display module to display an appropriate message indicating elapsed engine time.

20. The electronic control module of claim 7, wherein the central control module is programmed to cause the display module to display an appropriate signal or message when mower servicing is due.

21. The electronic control module of claim 7, wherein the mower cutting deck input device comprises a switch.

22. The electronic control module of claim 21, wherein the mower cutting deck input device comprises a switch with one or more pre-set positions or heights for the mower cutting deck.

23. The electronic control module of claim 7, wherein the mower cutting deck input device comprises a series of buttons representing one or more pre-set positions or heights for the mower cutting deck.

24. The electronic control module of claim 12, further wherein the Power Take Off switch is adapted to cause power to the mower blades to be turned on or off by means of an electric clutch mechanism, and the central control module is programmed to cause the electric clutch mechanism to engage the power to the mower blades smoothly and slowly.

25. The electronic control module of claim 1, further comprising a diagnostic key module removably plugged into the central control module, adapted to test the operation of the central control module and display module.

26. The electronic control module of claim 25, wherein the diagnostic key module is further adapted to test the operation and detect the presence of various input switches and devices, and adjust the display depending on what input switches and devices are present.

27. The electronic control module of claim 1, further comprising a language key module removably plugged into the central control module, said language key module causing any messages displayed by the display module to be in a particular language.

28. The electronic control module of claim 1, further comprising one or more mounting tabs extending from the edges of the central control module.
